(19) United States
(12) Patent Application Publication
(10) Pub. No.: US 2007/0144875 A1
(43) Pub. Date: Jun. 28, 2007

(54) Push button switch

(75) Inventor: Kenshi Nagata, Kurayoshi-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto (JP)

(21) Appl. No.: 11/643,511

(22) Filed: Dec. 21, 2006

(30) Foreign Application Priority Data
Dec. 26, 2005 (JP) 2005-372675

(51) Int. Cl. H01H 13/72

(52) U.S. Cl. 200/5 B

(57) ABSTRACT

The present invention provides a long-life push button switch having no variations in operation characteristics. A push button switch includes: a housing formed by a base in which fixed contacts are disposed on a bottom face, and a cover assembled to the base; an operating member slidably inserted in the axial direction in the housing; a guiding part which is formed obliquely from a ceiling face of the cover to the inside and along which the tip of an operation piece of the operating member slides; and a movable contact housed in the housing and pressed against the fixed contact, thereby opening a circuit. The guiding part along which the tip of the operating piece of the operating member can slide and a reinforcing part continued from the ceiling face of the cover at least on one side of the guiding part are formed at the edge of a through hole formed in the ceiling face of the cover.

### BACKGROUND OF THE INVENTION

1. Field of the Invention

The present invention relates to a push button switch and, more particularly, to a push button switch in which an operating member is inserted in the axial direction to open/close a contact.

2. Description of the Related Art

Hitherto, there is a push button switch in which an operating member assembled in a housing is pushed from a side to depress a movable contact to come into contact with a fixed contact, thereby opening/closing a circuit. For example, there is a push button switch in which a tilt piece 33 having a cantilever shape is cut from a center of the flat surface of a cover member 17 constructing a housing and an operating part 34 of an operating member 16 is pressed against the tilt piece 33, thereby depressing a movable contact 14 to open a circuit (refer to Japanese Unexamined Utility Model Publication No. Hei 5-83958).

There is another push button switch having a bent portion 35 in an almost V shape whose both ends are supported in a notch 34 in a pressing plate 33 as a component of a housing. By pressing a contact pressing portion 29 of an operating member 19 against the bent portion 35, a movable contact 18 is depressed to open a circuit (refer to Japanese Unexamined Utility Model Publication No. Hei 5-1126).

In the former push button switch, however, the tilt piece 33 has a cantilever shape, so that it tends to be elastic deformed. It is not easy to accurately push the movable contact, and the operation characteristics tend to vary.

In the latter push button switch, the bent portion 35 having an almost V shape whose both ends are supported has to be deep-drawn by press work. Consequently, the process face of the bent portion 35, in particular, the tilt surface with which the contact pressing portion 29 of the operating member 19 comes into press contact tends to become rough, and the operating member 19 sliding with the tilt surface wears easily, causing a problem such that the push button switch has short life.

The present invention has been achieved in view of the problems, and an object of the invention is to provide a long-life push button switch having no variations in its operation characteristics.

### SUMMARY OF THE INVENTION

To solve the problem, a push button switch according to the present invention includes: a housing formed by a base in which a fixed contact is disposed on a bottom face and a cover assembled to the base; an operating member slidably inserted in the axial direction in the housing; a guiding part which is formed obliquely from a ceiling face of the cover to the inside and along which the tip of an operation piece of the operating member slides; and a movable contact housed in the housing and pressed against the fixed contact, thereby opening a circuit, and the guiding part along which the tip of the operating piece of the operating member can slide and a reinforcing part continued from the ceiling face of the cover at least on one side of the guiding part are formed at the edge of a through hole formed in the ceiling face of the cover.

According to the present invention, since the guiding part along which the operating member slides is reinforced by the reinforcing member, the guiding part is not easily elastic-deformed unlike the conventional technique, so that the movable contact can be pressed accurately. Thus, a push button switch having no variations in the operation characteristics can be obtained.

Since the guiding part and the reinforcing part are continuously provided at the edge of the through hole formed in the ceiling face of the cover, like the conventional technique, it is unnecessary to perform deep drawing. Consequently, roughening of the sliding face of the guiding part is suppressed, and the tip of the operating member that slides along the guiding part is not easily worn out, so that a long-life push button switch is obtained. In particular, by performing the press work so that roughening of the face is concentrated in the reinforcing part to avoid occurrence of roughening in the guiding part, a longer-life push button switch is obtained.

As an embodiment of the invention, a frame member having an almost U shape and extending from the operating member may be guided along a pair of guide ribs projected in parallel with each other along both sides of the top face of the base.

In the embodiment, both sides of the operating member are accurately guided by the pair of guide ribs provided for the base. Therefore, a push button switch having no variations in operation characteristics can be obtained.

### BRIEF DESCRIPTION OF THE DRAWINGS

FIG. 1 shows a perspective view of an embodiment of a push button switch according to the present invention;

FIG. 2 shows an exploded perspective view of the push button switch illustrated in FIG. 1;

FIG. 3 shows a plan view of the push button switch illustrated in FIG. 1;

FIGS. 4A and 4B are cross sections taken along lines A-A and B-B, respectively, of FIG. 3;

FIG. 5 shows a cross section illustrating an operation state; and

FIGS. 6A and 6B show perspective view and cross section, respectively, of a cover single body shown in FIG. 1.

### DETAILED DESCRIPTION OF THE PREFERRED EMBODIMENTS

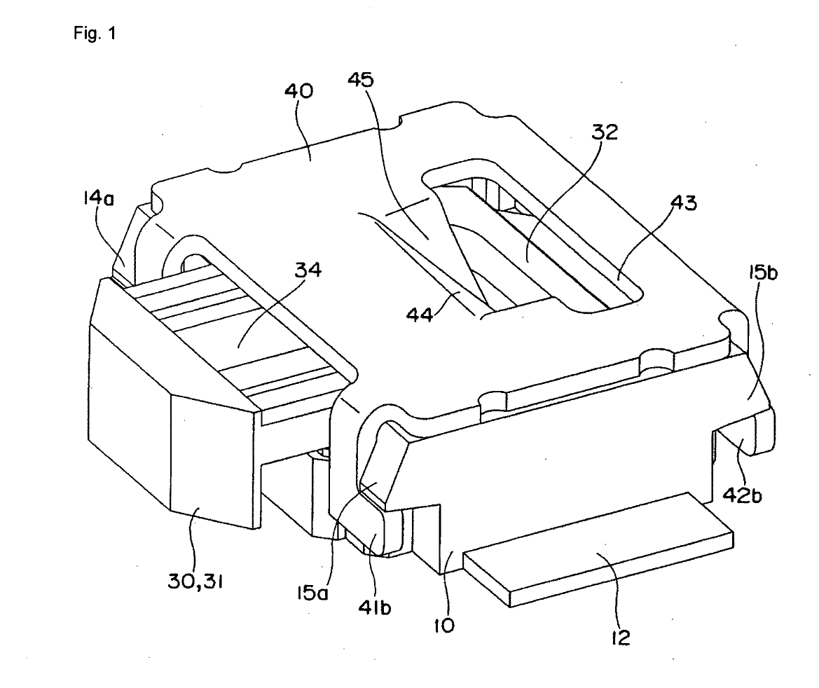

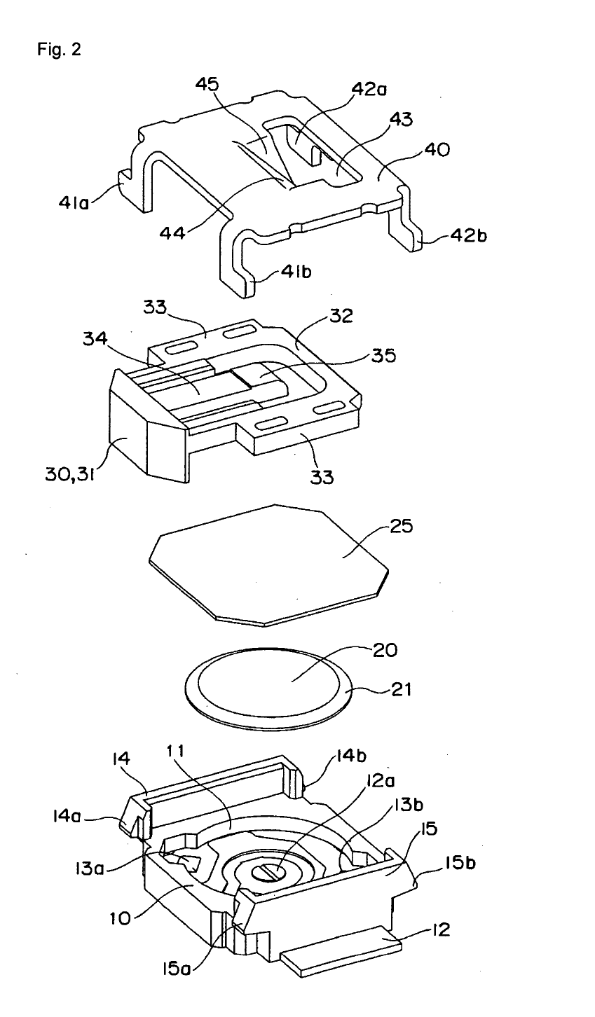

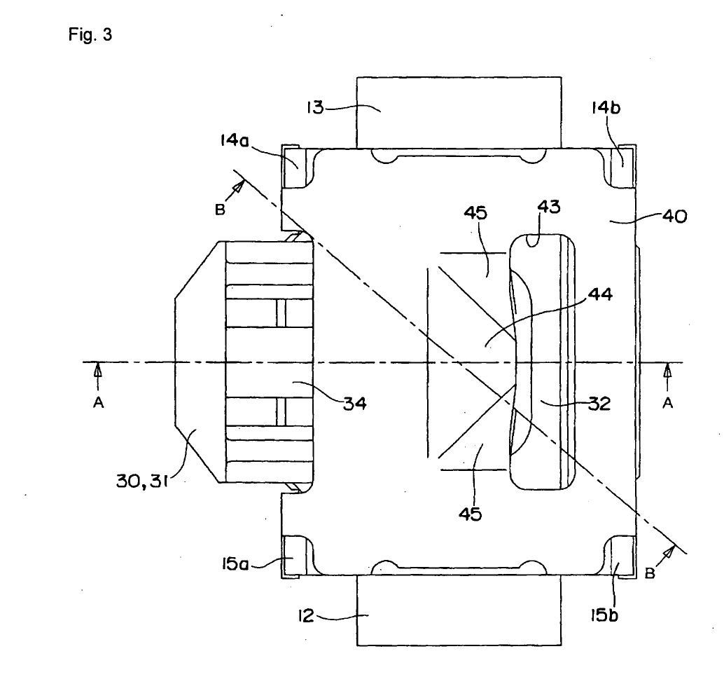

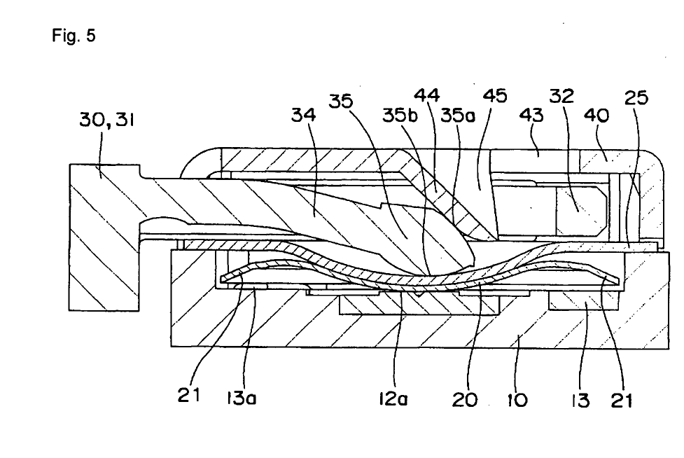

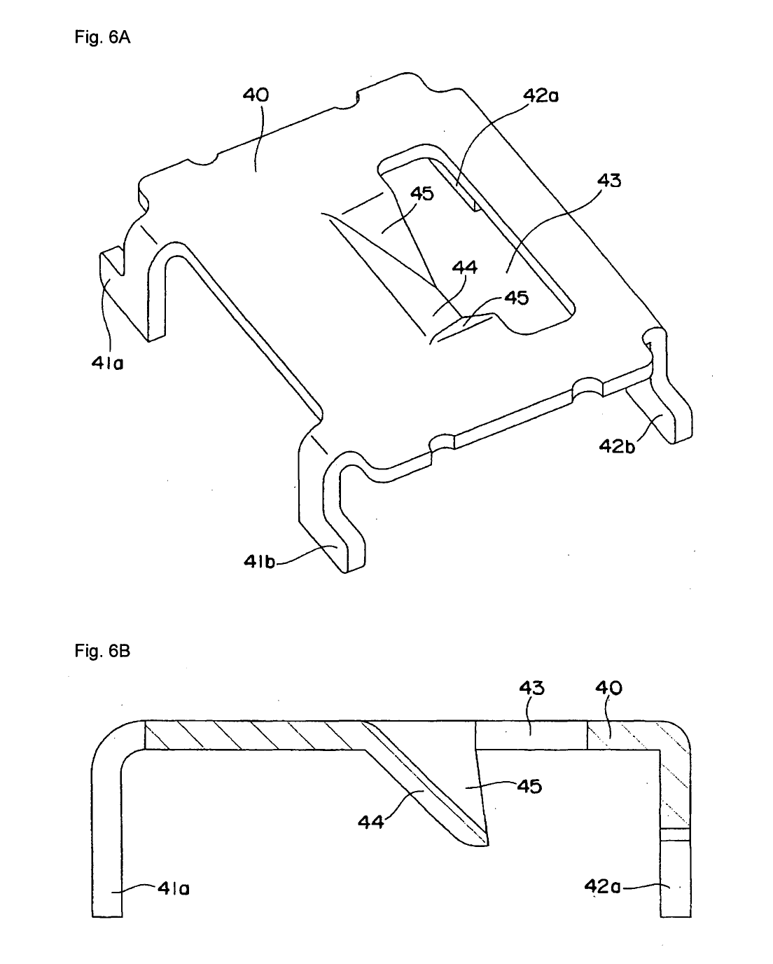

An embodiment of the present invention will be described with reference to the attached drawings of FIGS. 1 to 6.

A push button switch as an embodiment is constructed by a base 10, a movable contact 20, an insulating sheet 25, an operating member 30, and a cover 40.

A recess 11 having an almost circular shape in plan view is formed in the center of the top face of the base 10, a central fixed contact 12a conducted to a fixed contact terminal 12 is provided so as to project in the center of the bottom face of the recess 11, and a pair of fixed contacts 13a and 13b conducted to a fixed contact terminal 13 are disposed in opposite positions while sandwiching the central fixed contact 12a. Guide ribs 14 and 15 are provided so as to project at both facing sides of the top face of the base 10. Further, the guide rib 14 has engagement projections 14a and 14b at its ends, and the guide rib 15 has engagement projections 15a and 15b at its ends.

The movable contact 20 is made of an elastic conducting material and has a thin dome shape which can be fit in the recess 11 in the base 10. By fitting the movable contact 20 in the recess 11 in the base 10, an outer periphery 21 of the movable contact 20 comes into contact with the fixed contacts 13a and 13b.

The insulating sheet 25 has an almost quadrate shape capable of covering the plane of the base 10. By disposing the insulating sheet 25 between the guide ribs 14 and 15 of the base 10, the recess 11 is covered.

In the operating member 30, a frame member 32 having an almost U shape is integrally formed on one of faces of an operating part 31, and guide projections 33 and 33 are projected from facing side surfaces of the frame member 32. An operating piece 34 positioned in the frame body 32 is provided in the center of one of the surfaces of the operating part 31 so as to project to a side.

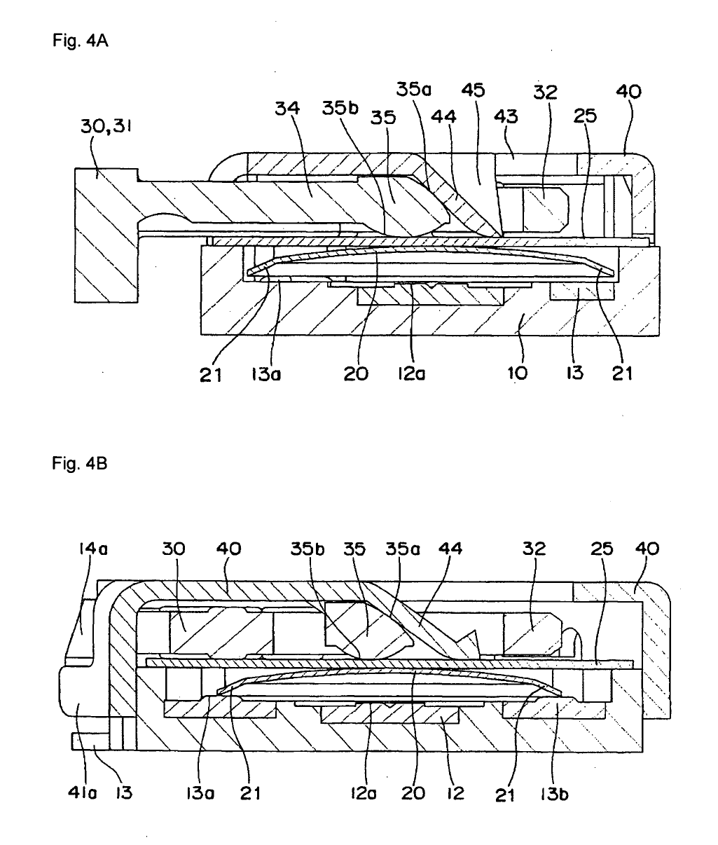

The frame member 32 of the operating member 30 is positioned between the guide ribs 14 and 15 of the base 10 and slidably assembled. Consequently, as shown in FIGS. 4A and 4B, an upper circular face 35a of the tip 35 of the operating piece 34 can come into contact with a guiding part 44 in the cover 40 which will be described later and a lower circular face 35b comes into contact to the movable contact 20 via the insulating sheet 25.

The cover 40 has a shape in plan view capable of covering the plane of the base 10. A pair of elastic engagement nails 41a and 41b and a pair of elastic engagement nails 42a and 42b of the cover 40 extend from both facing sides and are bent downward. In the cover 40, a through hole 43 having an almost rectangle shape is formed on one side of the plane and, by performing press work on a long side of the through hole 43, a guiding part 44 and reinforcing parts 45 and 45 on both sides of the guiding part 44 are formed.

When the cover 40 is attached to the base 10, the elastic engagement nails 41a, 41b, 42a, and 42b are elastically deformed to the outside and then come into engagement with the engagement projections 14a, 15a, 14b, and 15b of the base 10, respectively. Since the guiding part 44 of the cover 40 is positioned between the frame member 32 of the operating member 30 and the tip 35 of the operating piece 34, the operating member 30 is preventing from coming off.

A method of operating the push button switch having the above-described configuration will be described.

First, if it is before operation, as shown in FIG. 4A, the operating part 31 of the operating member 30 projects from the base 10. The upper circular face 35a of the tip 35 of the operating piece 34 is in contact with the under face of the guiding part 44, and the lower circular face 35b is in contact with the movable contact 20 via the insulating sheet 25. Further, the movable contact 20 is apart from the central fixed contact 12a.

When the operating part 31 of the operating member 30 is pushed, the guide projections 33 and 33 slide along the guide ribs 14 and 15. Consequently, the tip 35 of the operating piece 34 is pushed down along the guiding part 44, and the lower circular face 35b of the tip 35 pushes the center portion of the movable contact 20 down. When the center portion of the movable contact 20 is pushed down to a predetermined position and depressed, the movable contact 20 comes into contact with the central fixed contact 12a, and the central fixed contact 12a and the fixed contacts 13a and 13b are electrically connected. A narrow groove in an almost V shape in cross section is formed in the top face of the central fixing contact 12a in order to increase contact reliability.

After that, when the pressure applied on the operating member 30 is cancelled, the tip 35 of the operating piece 34 is pushed up by the spring force of the movable contact 20 and is pushed to a side by the horizontal component of the movable contact 20, and the operating member 30 returns to the original position. Since the frame member 32 is retained by the guiding part 44 and the reinforcing part 45, the operating member 30 does not come off from the base 10.

The push button switch according to the present invention is not limited to the configuration in which the reinforcing parts are provided on both sides of the guiding part of the cover but a reinforcing part may be provided only on one side of the guiding part.

What is claimed is:

1. A push button switch comprising:
a housing formed by a base in which a fixed contact is disposed on a bottom face and a cover assembled to the base;
an operating member slidably inserted in the axial direction in the housing;
a guiding part which is formed obliquely from a ceiling face of the cover to the inside and along which the tip of an operation piece of the operating member slides; and
a movable contact housed in the housing and pressed against the fixed contact, thereby opening a circuit,
wherein the guiding part along which the tip of the operating piece of the operating member can slide and a reinforcing part continued from the ceiling face of the cover at least on one side of the guiding part are formed at the edge of a through hole formed in the ceiling face of the cover.

2. A push button switch according to claim 1, wherein a frame member having an almost U shape and extending from the operating member is guided along a pair of guide ribs projected in parallel with each other along both sides of the top face of the base.
